(19) United States
(12) Patent Application Publication
(10) Pub. No.: US 2014/0113266 A1
(43) Pub. Date: Apr. 24, 2014

(54) Web Based Choice and Voting Presentation

(71) Applicant: Daron Fordham, Sherman Oaks, CA (US)

(72) Inventor: Daron Fordham, Sherman Oaks, CA (US)

(21) Appl. No.: 13/656,035

(22) Filed: Oct. 19, 2012

(51) Int. Cl. G09B 7/00

(52) U.S. Cl. 434/352

(57) ABSTRACT

A computer implementable system for establishing and managing visual images presenting a choice, and for presenting a voting functionality which may be implemented over the internet for example. The system may be linked to unrelated internet sites such as social networks for source material for the images, for displaying the images and voting functionality, and for displaying voting results. The system may be directly accessed from websites such as social network accounts, and may be structured to present the choice and voting functionality selectively to remote participants. A lightbox for generating suitable images from the internet may be provided.

### FIELD OF THE INVENTION

The present invention relates to computer implementable, wireless graphic communications messages which provide an observer with a visual choice between at least two competing images or concepts, and which invites the observer to choose between the two images or concepts.

### BACKGROUND OF THE INVENTION

Computers and wireless communications now enable a person to establish or to view graphic communications messages which invite observers to make a choice between two or more concepts, and to indicate their preference via a voting protocol. Although usable by many others, it is contemplated that commercial companies may exploit this type of communications message to promote sales of goods and services.

This concept is more fully set forth in U.S. Pat. No. 8,190,444, issued to Buadisch et al. on May 29, 2012, which patent is hereby incorporated by reference as though fully reproduced. While Baudisch et al. set forth a basic concept, their inventive concept is susceptible to certain improvements which may be introduced thereto.

### SUMMARY OF THE INVENTION

The present invention improves on known presentations of choices and subsequent voting protocols in certain ways. Illustratively, the concept may be implemented via integration with social networking to generate or retrieve images, both static and also in dynamic form such as videos, and textual statements, which may be used as the basis for offering choices to observers. Also, implementation of the concept may be shared to third party venues such as social networking sites, blog sites, and other websites. Further, it is possible to generate a listing of the inventive choice and voting protocols which have been generated by users on a home website dedicated to such choice and voting protocols. It is also possible to make a website interactive in a way that enables a home website user to create a choice and voting protocol as a pop-up window or lightbox occupying the latest current page being viewed by a user. The window or lightbox may include prompts enabling the user to establish the choice and voting protocol, and to upload to or link to external sites such as Youtube or Vimeo video. An option is provided to conduct final editing and changing prior to posting the newly established choice and voting protocol to public access.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a representation of an exemplary graphic choice and voting functionality which is at the center of the present invention.

FIG. 2 is a representation of apparatus which may be utilized to implement the present invention.

### DETAILED DESCRIPTION

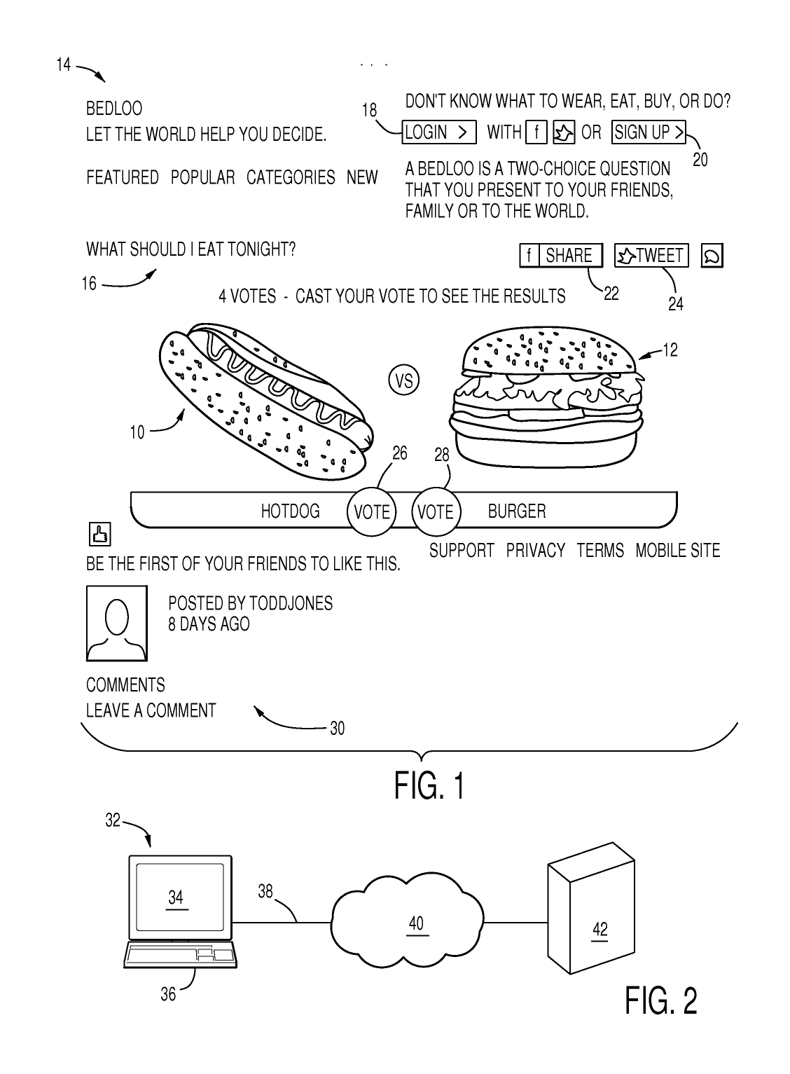

FIG. 1 shows a representation of an exemplary graphic choice and voting functionality which be utilized in a computer implementable system for presenting a choice to remote observers and enabling the remote observers to vote on the choice. The novel computer implementable system may be the product of for example an on-line polling application which presents choices to the on-line public. Although description of the system herein is presented generically, it is contemplated that the system may be used by companies and other commercial entities, for purposes of popularizing and promoting their products for example.

Elements of the graphic choice include a first image 10 depicting a hotdog and a second image 12 depicting a hamburger. In the present example, the first image 10 and second image 12 are arrayed beside one another as part of the graphic content of a computer display screen 14. While this juxtaposed relationship is not absolutely critical, it is strongly preferred that the first image 10 and second image 12 be sufficiently close in proximity so as to invite visual comparison by an observer (not shown). Also, the subject matter of the first image 10 and the second image 12 are preferably thematically related to each other so as to intuitively pose or suggest a choice. In the present example, not only are the hot dog and hamburger both foods, but both are shown prepared, presumably hot and ready to eat, and both of types that are frequently available for consumption in the same venue. The display screen 14 may also include graphic elements including a question rendered as text 16, log-in and sign-on icons 18, 20, a share icon 22, a tweet icon 24, a first voting icon 26, a second voting icon 28, and a fillable space 30 for entering a comment. The log-in and sign-on icons 18, 20, the share icon 22, and the tween icon 24 may operate conventionally to accomplish the functions their respective names imply. The voting icons 26, 28 may record and transmit data corresponding to a vote or choice to be made by the observer. In the present example, the observer would enter a vote according to his or her preference for the hot dog 10 or the hamburger 12. The corresponding data could be transmitted remotely or alternatively, processed locally for tallying and reporting.

Referring also to FIG. 2, the apparatus of the novel system may include a data processor 32, which may comprise a personal computer, tablet, or other electronic data processing enabled device, including those incorporating telecommunications capability. The data processor 32 may include a display screen 34 and a data entry device such as a keyboard 36, but also, a computer mouse, a joystick, and other data entry devices (none shown) capable of entering data and commands. The data processor 32 may include a hard wired or wireless connection 38 to the internet 40, and if desired, a remote server 42 or other data processing device which will enable the functions described herein to be accomplished.

The data processor 32 may have loaded therein first computer instructions which are functional to generate at least a first graphic presentation and a second graphic presentation which are simultaneously displayed to the observer or user of the data processor 32. The first image 10 serves as a first graphic presentation, and the second image 12 serves as a second graphic presentation, which are thematically related such that together they pose a choice to the observer. The data processor may have loaded therein second computer instructions which are functional to generate a graphic presentation which may be used to by the observer to select one of the first and second graphic presentations, this being in the present example the first voting icon 26 and the second voting icon 28.

The share icon 22 and the tweet icon 24 may be functional to summon a social network site for display on the display screen 34 and to obtain a graphic presentation from the social network site for incorporation into the graphic presentations which are thematically related to pose the choice.

Examples of suitable forms of the first graphic presentation and the second graphic presentation include static cropped images displayed in close proximity to one another. Other suitable forms may include dynamic video images displayed in close proximity to one another. A third example of a suitable form is textual displays displayed in close proximity to one another.

The computer implementable system may comprise an automated transfer protocol which on command by an originator of the first graphic presentation and a second graphic presentation are simultaneously displayed to be entered into a remote website presence. An example of such a remote website presence is a social network such as Twitter® or Facebook®. Another example of a remote website presence is a personal blog site. The data processor 32 may have loaded therein computer instructions which are functional to enter the first graphic presentation and the second graphic presentation into the website presence by copying an HTML code by a single manual command, such as by clicking on an icon dedicated to the embedding function.

Additional functionalities may be provided. The computer implementable system may comprise computer instructions which are functional to effect logging into a website presenting first graphic presentation, the second graphic presentation, and the graphic presentation which may be used to by the observer to select one of the graphic presentations via a social network profile.

The computer implementable system may comprise computer instructions which are functional to embed a first graphic presentation such as the image 10, a second graphic presentation such as the image 12, and the voting functionality which has been generated by a user of the computer implementable system into a social network account of the observer by a single command. As intended herein, a single command may require that the user or observer click on a specific icon on the computer screen 14 or perform a corresponding action requiring a single keystroke, touching of the screen or gesture, where the system utilizes touch or gesture driven commands, to effect embedment. A dedicated button or icon may be provided to enable a single action command to effect embedment. Such a single command may result in copying an HTML code for example.

The computer implementable system may comprise computer instructions which are functional to establish a list view of plural first graphic presentations, second graphic presentations, and the graphic presentation which may be used to by the observer to select one of the graphic presentations and to display the list view. This list may be arrayed vertically as a columnar list for example. The computer instructions enabling generation and display of a list may also be functional to restrict access to the list view to users who are logged in to a website which displays the list view.

The computer implementable system of may comprise computer instructions which are functional to display the first graphic presentation, second graphic presentation, and the voting functionality on a single screen such as the screen 14 together with selectable virtual command prompts which are selectable to effect any one of a vote by an observer to indicate selection of the choices; to share the first graphic presentation, second graphic presentation, and the voting functionality to another site; to embed the first graphic presentation, second graphic presentation, and the voting functionality into a selected web page; and to post a comment which is visible with the first graphic presentation, second graphic presentation, and the voting functionality which may be used to by the observer to select one of the graphic presentations.

Another feature which may be practiced with the novel computer implementable system is that of incorporating computer instructions which are functional to establish a lightbox which is automatically displayed on a current page of a website being viewed by the observer.

A further functionality which may be provided by the novel computer implementable system is that of providing computer instructions which are functional to present a list view of selected ones of the first graphic presentation, second graphic presentation, and the voting functionality as a page which is available only to logged in users followed by the observer.

The novel computer system may be implemented as a stand-alone application dedicated to generation and display of plural first graphic presentations such as the image 10, the second graphic presentation such as the image 12, and the voting functionality or graphic presentation which may be used to by the observer to select one of the graphic presentations are implemented as an online application which is dedicated to this purpose and which may be downloaded to a personal data processor such as the data processor 32. Alternatively, the novel computer system may reside in a remote server such as the remote server 42. Functional components of the novel computer system may be split between two or more data processing devices such as the data processor 32 and the remote server 42.

The novel system may be presented as a multi-page website. One page may feature a list view dominated by highest voting totals. Presence of a choice and voting presentation may have a finite life on the website, and may be purged as a function of residence time, popularity as reflected by voting totals, or due to other factors.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A computer implementable system for presenting a choice to remote observers and enabling the remote observers to vote on the choice, comprising a data processor having an associated display disposed to display at least one display screen and having loaded in the data processor
first computer instructions which are functional to generate at least a first graphic presentation and a second graphic presentation which are simultaneously displayed to an observer and which are thematically related such that together they pose a choice to the observer;
second computer instructions which are functional to generate a graphic presentation which may be used to by the observer to select one of the first and second graphic presentations; and
third computer instructions which are functional to summon a social network site for display on the display screen and to obtain a graphic presentation from the social network site for incorporation into the graphic presentations which are thematically related to pose the choice.

2. The computer implementable system of claim 1, wherein the first graphic presentation and the second graphic presentation are static cropped images displayed in close proximity to one another.

3. The computer implementable system of claim 1, wherein the first graphic presentation and the second graphic presentation are dynamic video images displayed in close proximity to one another.

4. The computer implementable system of claim 1, wherein the first graphic presentation and the second graphic presentation are textual displays displayed in close proximity to one another.

5. The computer implementable system of claim 1, further comprising an automated transfer protocol which on command by an originator of the first graphic presentation and a second graphic presentation which are simultaneously displayed to be entered into a website presence.

6. The computer implementable system of claim 5, wherein the website presence is a social network.

7. The computer implementable system of claim 5, wherein the website presence is a personal blog site, and the data processor has loaded therein fourth computer instructions which are functional to enter the first graphic presentation and the second graphic presentation into the website presence by copying an HTML code by a single manual command.

8. The computer implementable system of claim 1, wherein the first graphic presentation, the second graphic presentation, and the graphic presentation which may be used to by the observer to select one of the graphic presentations are implemented on an online application which is dedicated to generation and display of plural first graphic presentations, second graphic presentations, and graphic presentations which may be used to by the observer to select one of the graphic presentations.

9. The computer implementable system of claim 1, further comprising fifth computer instructions which are functional to effect logging into a website presenting first graphic presentation, the second graphic presentation, and the graphic presentation which may be used to by the observer to select one of the graphic presentations via a social network profile.

10. The computer implementable system of claim 1, further comprising sixth computer instructions which are functional to embed a first graphic presentation, the second graphic presentation, and the graphic presentation which may be used to by the observer to select one of the graphic presentations which has been generated by a user of the computer implementable system into a social network account of the observer by a single command.

11. The computer implementable system of claim 1, further comprising seventh computer instructions which are functional to establish a list view of plural first graphic presentations, second graphic presentations, and the graphic presentation which may be used to by the observer to select one of the graphic presentations and to display the list view.

12. The computer implementable system of claim 11, wherein the first graphic presentations, second graphic presentations, and the graphic presentation which may be used to by the observer to select one of the graphic presentations are displayed as a columnar list.

13. The computer implementable system of claim 11, wherein the seventh computer instructions are functional to restrict access to the list view to users who are logged in to a website which displays the list view.

14. The computer implementable system of claim 1, wherein the first and second computer instructions are functional to display the first graphic presentation, second graphic presentation, and the graphic presentation which may be used to by the observer to select one of the graphic presentations on a single screen together with selectable virtual command prompts which are selectable to effect any one of
a vote by an observer to indicate selection of the choices,
to share the first graphic presentation, second graphic presentation, and the graphic presentation which may be used to by the observer to select one of the graphic presentations to another site,
to embed the first graphic presentation, second graphic presentation, and the graphic presentation which may be used to by the observer to select one of the graphic presentations into a selected web page, and
to post a comment which is visible with the first graphic presentation, second graphic presentation, and the graphic presentation which may be used to by the observer to select one of the graphic presentations.

15. A computer implementable system for presenting a choice to remote observers and enabling the remote observers to vote on the choice, comprising a data processor having a display screen communicably thereto and having loaded in the data processor
first computer instructions which are functional to generate at least a first graphic presentation and a second graphic presentation which are simultaneously displayed to an observer and which are thematically related such that together they pose a choice to the observer;
second computer instructions which are functional to generate a graphic presentation which may be used to by the observer to select one of the graphic presentations; and
third computer instructions which are functional to establish a lightbox which is automatically displayed on a current page of a website being viewed by the observer.

16. A computer implementable system for presenting a choice to remote observers and enabling the remote observers to vote on the choice, comprising a data processor having a display screen communicably thereto and having loaded in the data processor
first computer instructions which are functional to generate at least a first graphic presentation and a second graphic presentation which are simultaneously displayed to an observer and which are thematically related such that together they pose a choice to the observer;
second computer instructions which are functional to generate a graphic presentation which may be used to by the observer to select one of the graphic presentations; and
third computer instructions which are functional to present a list view of selected ones of the first graphic presentation, second graphic presentation, and the graphic presentation which may be used to by the observer to select one of the graphic presentations as a page which is available only to logged in users followed by the observer.
